(19) United States
(12) Patent Application Publication
(10) Pub. No.: US 2022/0363437 A1
(43) Pub. Date: Nov. 17, 2022

(54) STORAGE BIN STACKING AND LABELING CLIP

(71) Applicant: Jasper & Black, Tucson, AZ (US)

(72) Inventor: Jeremy P. Black, Tucson, AZ (US)

(21) Appl. No.: 17/320,783

(22) Filed: May 14, 2021

(51) Int. Cl. B65D 21/02; B65G 57/00

(52) U.S. Cl. CPC B65D 21/0224; B65G 57/005

(57) ABSTRACT

A storage bin stacking clip for clipping to a top edge of a first storage bin and for supporting a second storage bin stacked upon the first storage bin. The stacking clip comprises: a bin support base including a base surface and defining a base opening; a front plate connected to the bin-support base, the front plate extending transversely from the base and including a front surface; a bin stop tab extending from the front plate and including a front stop tab surface, the front stop tab surface being coplanar with the front surface of the front plate such that the front stop tab surface and the front surface of the front plate form a continuous front surface, the bin stop tab defining a stop tab length that is less than the base length; and one or more support arms extending transversely from the base.

### FIELD OF THE INVENTION

The present invention is generally directed to clips. More specifically, the present invention is directed to stacking and labeling clips for attaching to storage bins to facilitate the stacking of the storage bins, for labeling the storage bins, and related systems and methods thereof.

### BACKGROUND OF THE INVENTION

Containers, bins, and boxes are commonly used to hold or store various items. Often times, such storage bins include lids, and are configured to be stacked one on top of the other. Known bins made of plastic materials are often configured to be stackable, and include lids to aid in stacking. However, oftentimes, storage bins may not be stackable, particularly those with open tops, i.e., no lid.

Although some devices for stacking bins and containers are known, such systems may be inconvenient to use, requiring the use of multiple components, may be difficult to manufacture, and may not yield stable stacks of bins when used.

Also, many storage bins are not suited for labeling, such as storage bins with textured sides, or with sides comprising woven, fabric or natural materials, such as jute, wood, and so on. It can be difficult for a user to attach a label to the exterior of such storage bins, particularly because an adhesive-backed label may not securely attach to such material. This is especially inconvenient if bins are stacked upon each other.

Further, the use of permanent or semi-permanent labels, rather than removable or reusable labels poses another inconvenience for a user.

### SUMMARY

Embodiments of the invention resolve many of the known deficiencies of known storage bin clips and clip systems by providing a user-friendly, easy-to-manufacture universal stacking and labeling clip that includes stop tab structures that prevent movement of stacked bins and provide a gripping structure for a user and a guide for label insertion, an extended base for supporting a stacked storage bin, including bins of different sizes, clip arms that apply a spring force to secure the clip to the bin, and a labeling system that accommodates bins made of rough, woven or fibrous materials, as described in detail below.

An embodiment of the disclosure includes a storage bin stacking clip for clipping to a top edge of a first storage bin and for supporting a second storage bin stacked upon the first storage bin that comprises: a bin support base including a base surface and defining a base opening; a front plate connected to the bin-support base, the front plate extending transversely from the base and including a front surface, which can serve as a labeling surface; a bin stop tab extending from the front plate and including a front stop tab surface, the front stop tab surface being coplanar with the front surface of the front plate such that the front stop tab surface and the front surface of the front plate form a continuous front surface, the bin stop tab defining a stop tab length that is less than the base length; and one or more support arms extending transversely from the base.

Another embodiment of the disclosure is a storage bin stacking and labeling clip for clipping to a top edge of a first storage bin and for supporting a second storage bin stacked upon the first storage bin, and for displaying a storage bin label. The stacking and labeling clip comprises: a bin support base including a base surface, defining a base length and a base width; a front plate connected to the bin-support base, the front plate extending transversely from the bin-support base and including a front surface, and a label-holding portion defining a slot configured to receive a portion of a label; a bin stop tab extending from the front plate and including a front stop tab surface, the front stop tab surface being coplanar with the front surface of the front plate such that the front stop tab surface and the front surface of the front plate form a continuous front surface, the bin stop tab defining a stop tab length and a stop tab height; and one or more support arms extending transversely from the bin-support base.

Another embodiment comprises a method of manufacturing a unitary stacking and labeling clip, which comprises one or more of the following steps: providing a substantially flat, bendable sheet-like material; cutting, etching or punching a pattern onto the flat sheet to define a front plate, a stop tab, a base, arms, and label-holding portions; bending the portion of the flat sheet corresponding to the base rearwardly and away from the portion defined as the front plate, leaving the stop tab extending upward and away from the front plate and forming an opening, and causing the base to be at an acute angle with the front plate; bending the portion of the sheet corresponding to the arms downwardly and away from the base 106 to form the arms; and bending the portion of the sheet corresponding to the label-holding portions to form slots configured to receive a storage bin label.

In yet another embodiment, the present disclosure includes a method of stacking and labeling storage bins, which include some or all of the following steps:
1) Grasping a first stacking and a storage clip, the stacking and storage clip having a base, front plate, stop tab, and one or more support arms;
2) Placing the stacking and labeling clip directly onto a top edge of first storage bin, such as a first edge, such that a bottom of the storage clip directly contacts the first edge, the stop tab projects above the first edge, and the support arms exert a force onto walls of the storage bin;
3) Placing a second stacking clip on a second top edge of the first storage bin at a position opposite the first stacking clip, such that the stop tab of the first stacking clip projects above the second edge and faces the stop tab of the oppositely positioned first stacking clip;
4) Grasping and lifting the second storage bin to align the second storage bin between the two stop tabs of the clips;
5) Placing the second storage bin on the two base portions of clips; and
6) Inserting a label into a label-holding portion of one of the clips, or marking the front surface of the front plate with storage information.

### BRIEF DESCRIPTION OF THE FIGURES

The invention can be understood in consideration of the following detailed description of various embodiments of the invention in connection with the accompanying drawings, in which:

FIG. 1 is a rear perspective view of the stacking and labeling clip, according to an embodiment of the invention;

FIG. 2 is a rear view of the stacking and labeling clip of FIG. 1;

FIG. 3 is a front view of the stacking and labeling clip of FIG. 1;

FIG. 4 is a top view of the stacking and labeling clip of FIG. 1;

FIG. 5 is a bottom view of the stacking and labeling clip of FIG. 1;

FIG. 6 is a right-side view of the stacking and labeling clip of FIG. 1;

FIG. 7 is a left-side view of the stacking and labeling clip of FIG. 1;

FIG. 8 is a rear perspective view of the stacking and labeling clip, according to another embodiment of the invention;

FIG. 9 is a rear view of the stacking and labeling clip of FIG. 8;

FIG. 10 is a front view of the stacking and labeling clip of FIG. 8;

FIG. 11 is a top view of the stacking and labeling clip of FIG. 8;

FIG. 12 is a bottom view of the stacking and labeling clip of FIG. 8;

FIG. 13 is a right-side view of the stacking and labeling clip of FIG. 8;

FIG. 14 is a left-side view of the stacking and labeling clip of FIG. 8;

FIG. 15 depicts a pair of stacking and labeling clips connected to a first storage bin;

FIG. 16 is a left-side view of one of the pair of stacking and labeling clips connected to the first storage bin of FIG. 15, with a side wall of the bin shown in cross section;

FIG. 17 depicts a second storage bin stacked on the first storage bin and clips of FIG. 15; and

FIG. 18 is a left-side view of the one of the pair of stacking and labeling clips connected to the first storage bin of FIG. 15, also depicting a second storage bin stacked upon the first storage bin, with side walls of the bins shown in cross section.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

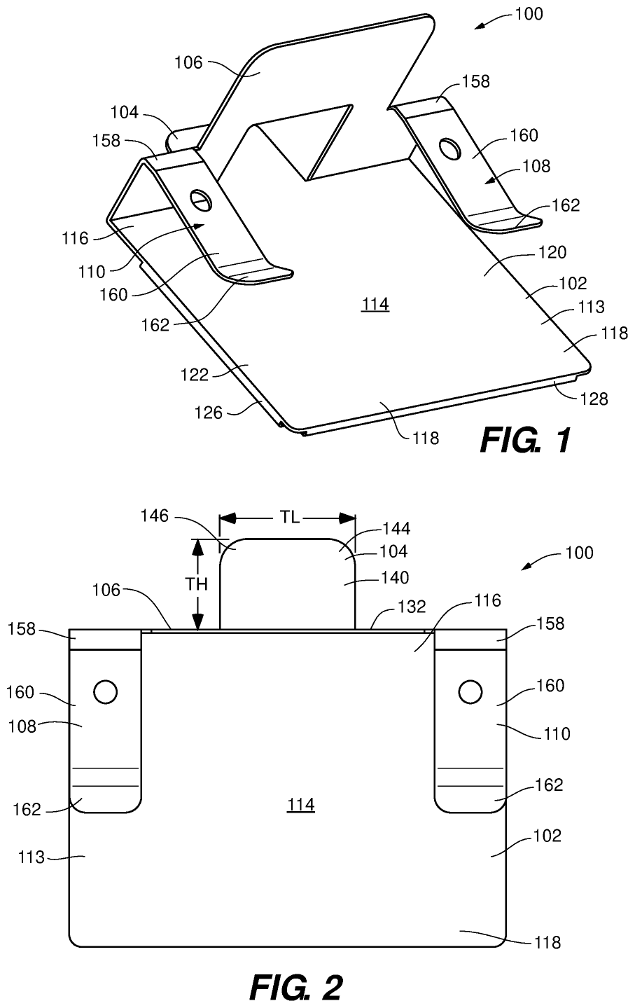

Referring to FIGS. 1-7, a first embodiment of storage-bin stacking and labeling clip (“stacking clip”) 100 is depicted. In the embodiment depicted, stacking clip 100 includes front vertical support and labeling plate portion (“front plate”) 102, bin stop tab (“stop tab” or “tab”) 104, bin-support base portion (“base”) 106, first support arm 108, and second support arm 110.

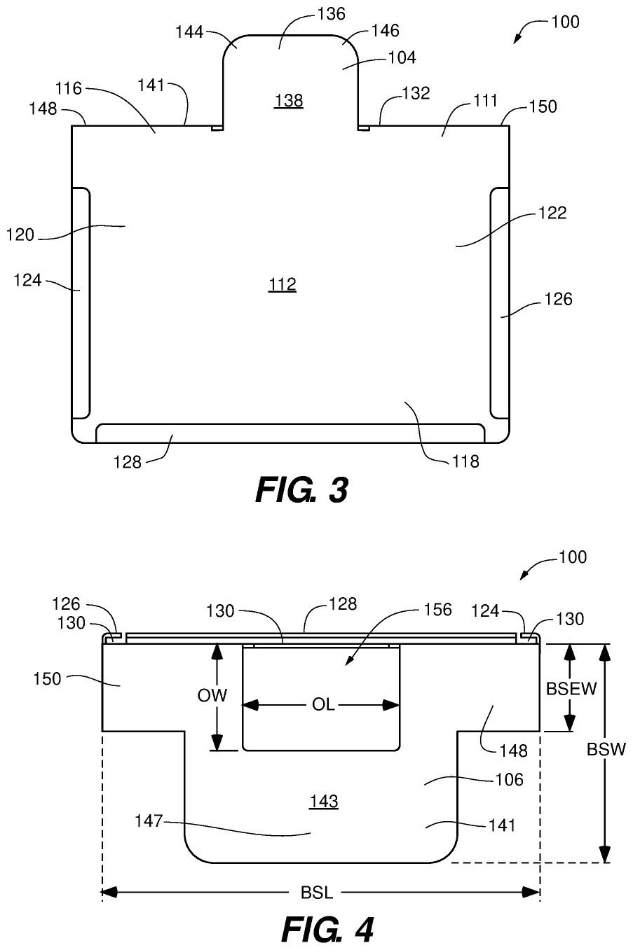

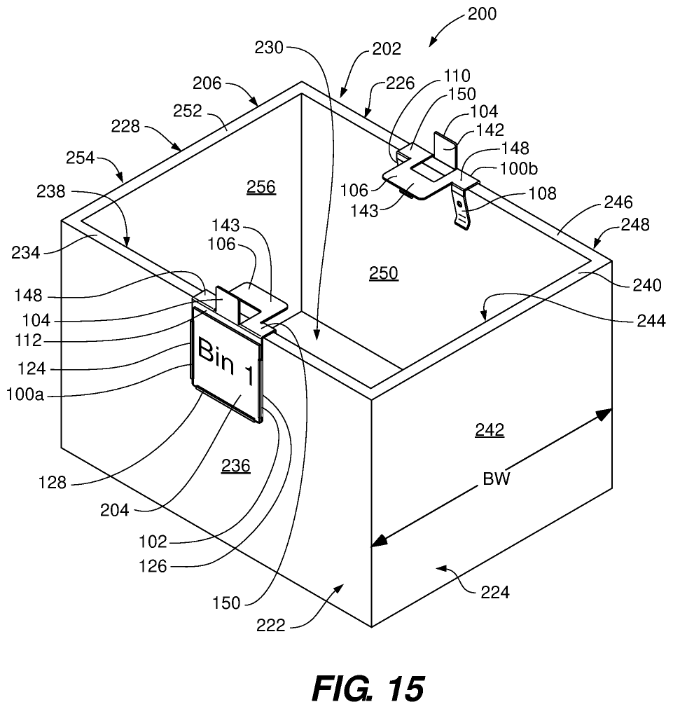

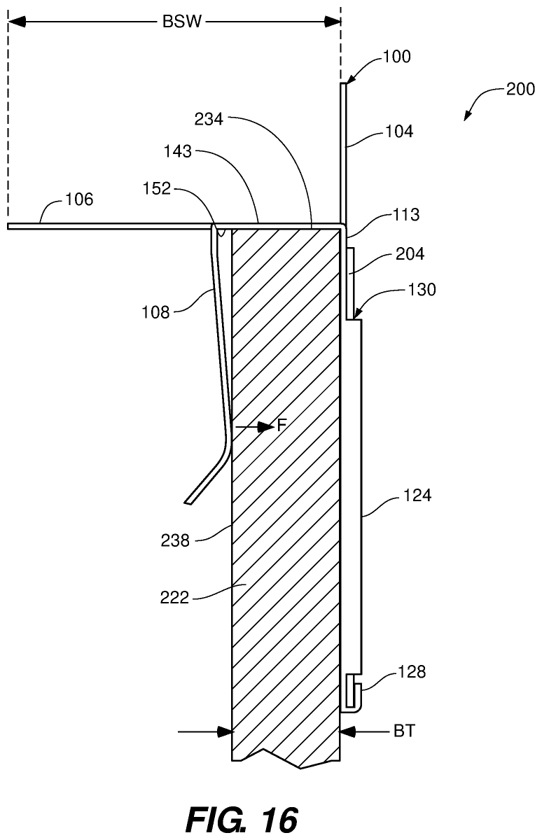

In an embodiment, and as depicted, front plate 102 comprises a substantially flat, planar or plate-like portion that includes front side 111 with surface 112, which may be a labeling surface, or storage/content information display surface, and rear side 113 with surface 114 configured to abut a side of a storage bin 202 (see also FIGS. 15 and 16 depicting storage system 200 that includes a plurality of stacking clips 100 on a plurality of storage bins 202, with one or more labels 204). Front plate 102 also includes top plate portion 116, bottom plate portion 118, left or first plate portion 120 and right or second plate portion 122. Referring specifically to FIGS. 3 and 4, front plate 102 may also include a plurality of label alignment, holding and displaying portions 124, 126 and 128 (“label-holding portions”). Label holding portions include first or left label-holding portion 124, second or right label-holding portion 126 and third or bottom label-holding portion 128. In conjunction with surface 112, label-holding portions 124, 126 and 128 each form and define label-receiving channels, grooves or slots 130. Slots 130 are configured to receive portions, such as edge portions of a storage bin label 204 (label 204 in slots 130 is depicted in FIGS. 15-18).

In an embodiment, and as depicted, each label-holding portion 124, 126, and 128 is formed of a portion of front plate 102, the label-holding portion being bent or otherwise formed to extend from a respective edge of front plate 102 and project over a portion of surface 112 of front plate 102 to form slot 130.

In some embodiments, and as described further below, rather than insert a label 204 to identify a bin or its contents, a user may prefer to write information directly onto surface 112 of front plate 102. A user may write directly on surface 112 with a marking device that is intended to make erasable or temporary markings, such as a dry-erase or chalk marker, or similar marking device.

In such an embodiment, front plate 102, with or without label-holding portions 124-128, may include surface 112 that is configured to be directly written on. As described, surface 112 is substantially flat, thereby making it easy for a user to write on surface 112 with a marking device. Further, surface 112 may also include a film, finish or coating that is configured to receive a marking substance, e.g., erasable ink, chalk, etc., from the marking device, and allow it to be erased or otherwise removed. In an embodiment, clip 100 and its labeling surface 112 may comprise a steel material with a coating or thin film laminate.

In another similar embodiment, surface 112 is covered with, or comprises, a sheet-like material, with or without a coating, that is configured to receive the marking substance from the marking device, and allow it to be erased or otherwise removed, similar to a dry-erase or white-board material. Such a material may comprise, but not be limited to, plastic, such as melamine, glass, porcelain, or a file-coated paper.

In another embodiment adapted for direct marking, clip 100 may not comprise a unitary structure, but may comprise an assembly that includes a front plate 102 with a surface 112 configured to be written on. In one such embodiment, front plate 102, and optionally, stop tab 104, may comprise a second material, such as wood, plastic, glass or another suitable markable material, which may include a coating, finish or film as described above. Wood materials may include bamboo, birch, or another species with readily-visible wood-grain structure. The other structural components of clip 100, other than front plate 102 (and optionally stop tab 104), e.g., base 106, may comprise a different material, such as metal, e.g., steel.

In an embodiment, front plate 102 is attached to the other structural components with glue or adhesive, with fasteners, or with other means. In an embodiment, front plate 102 may be attached to a small plate or other structure not depicted, that extends downward from base 106.

Referring specifically to FIGS. 6 and 7, front plate 102 includes a thickness t, which in an embodiment, is substantially uniform across all portions of front plate 102.

Referring to FIGS. 2, 3, 6 and 7, stop tab 104, in an embodiment, comprises a substantially flat, plate-like portion that is joined to front plate 102, and that extends vertically, or upwardly away from front plate 102 at top edge 132. Stop tab 104 includes front side 136 with front surface 138 and rear side 140 with rear surface 142, left or first corner 144 and right or second corner 146. In an embodiment, left corner 144 and right corner 146 may each be rounded, so as to prevent damage to a bin should the bin inadvertently be pressed against a portion, including a corner, of stop tab 104 during use, i.e., stacking of bins. Rounded corners 144 and 146 also minimize the risk of injury to a user handling clip 100.

In an embodiment, stop tab 104 defines a quadrilateral shape, for example, a rectangular or square, for easy grasping by a user, and for acting as a label guide, as described further below.

Stop tab 104 defines a stop tab length TL and a stop tab height TH. In an embodiment, and as depicted, stop tab length TL is less than a length BSL of base 106.

In the embodiment depicted, stop tab 104 is integral with front plate 102, such that stop tab 104 and front plate 102 form a unitary plate. In such an embodiment, front surface 138 of stop tab is continuous with front surface 112 of front plate 102, and devoid of any significant surface deviations between surfaces 138 and 112. The surfaces 138 and 112 may be coplanar as depicted. As described further below, the continuous coplanar feature of surfaces 138 and 112 makes it easier for a user to align and insert a label or label card into slots 130 formed by the label-holding portions 124 and 126 by acting as an alignment guide for label 204.

In an embodiment, stop tab 104 may comprise a thickness t that is the same thickness as front plate 102.

Base 106, in an embodiment, and as depicted, forms a plate-like or shelf-like portion of stacking clip 100, which may be generally “U” shaped as depicted, and includes top side 141 with top surface 143, bottom side 145 with bottom surface 149, and middle portion 147, left side 148 and right side 150. Bottom surface 149 includes bottom left-side surface portion 152 and bottom right-side surface portion 154. Base 106 defines a base length BSL and a base width BSW, as depicted in FIG. 4. Left side 148 and right side 150 each define a width BSEW (base end width). A width of middle portion 147 is the same as BSW.

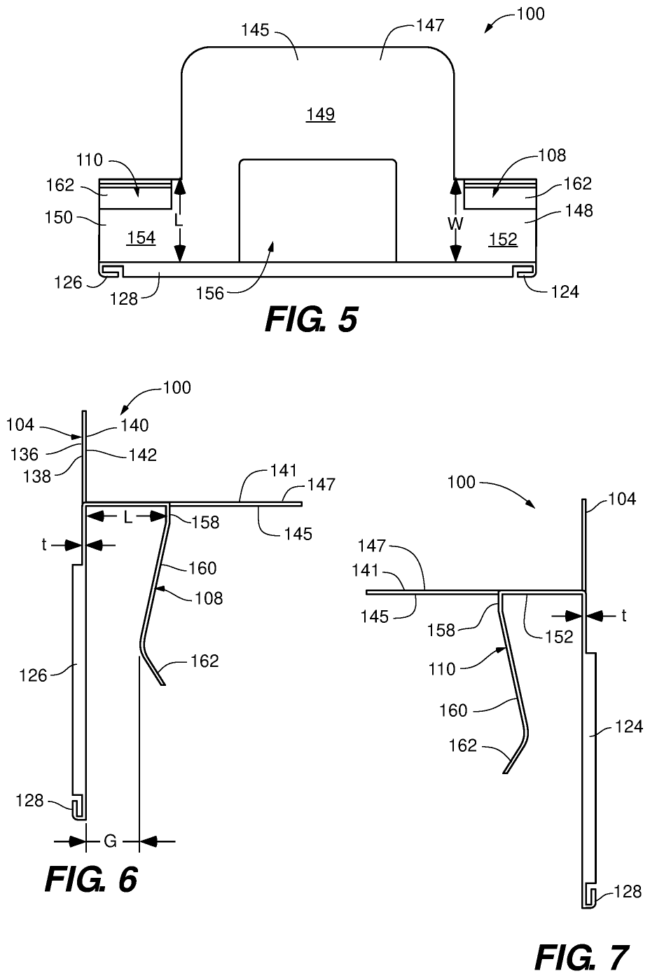

In an embodiment, bottom left-side surface portion 152 and bottom right-side surface portion 152 are each substantially flat and lie in a common plane, and are configured to contact a top edge of storage bin 202 (see also FIG. 15). Bottom left-side surface portion 152 and bottom right-side surface portion 154 each define a length L in a front-to-rear direction (See also FIGS. 5-6).

In an embodiment, and as depicted, base 106 also defines opening 156. In an embodiment, and as described further below, during manufacturing of stacking clip 100, an outline cut of stop tab 104 is made in a blank plate, and base 106 is bent out of the plane defined by front plate 102, thereby creating opening 150 which has approximately the same dimensions as stop tab 104, or slightly larger dimensions than stop tab 104 due to material loss or removal during manufacturing. In an embodiment, a length OL of opening 156 is substantially equal to, or slightly larger than, a length of stop tab 104, and a width OW of opening 156 is substantially equal to, or slightly larger than a height TH of stop tab 104.

Opening 156 may be sized to receive one or more fingers of a user's hand. Such a configuration allows a user to insert fingers through opening 156 and grasp middle portion 147 of base 106, making it easy for a user to generally handle clip 100, including making it easier to align and push clip 100 onto an edge of storage bin 202 (see also FIG. 15). In an embodiment, a width of opening 156 is greater than a length of opening 156 (with reference to base 106 length and width), so as to receive more than one finger of a user's hand, and to appropriately size stop tab 104.

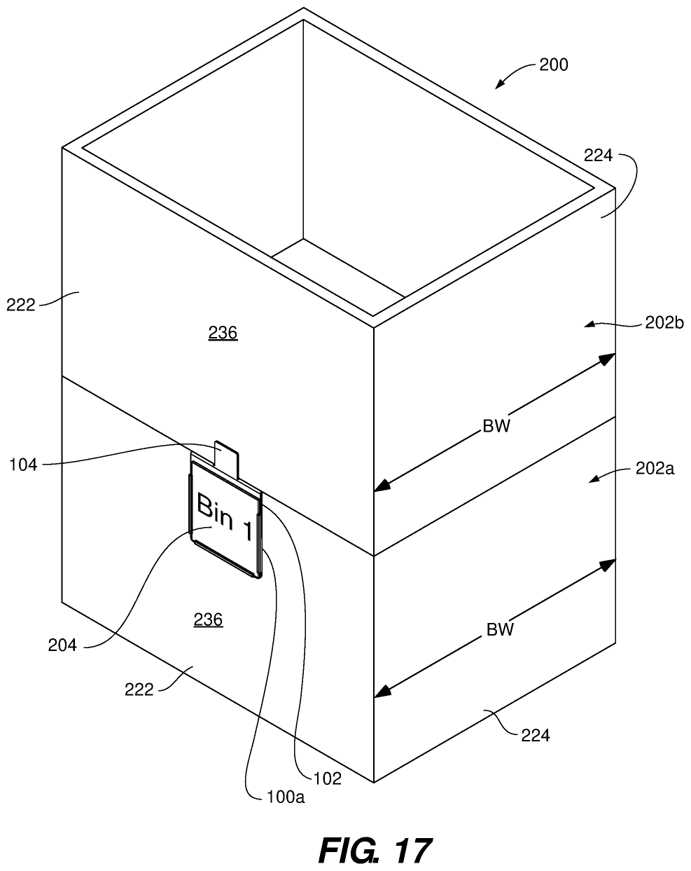

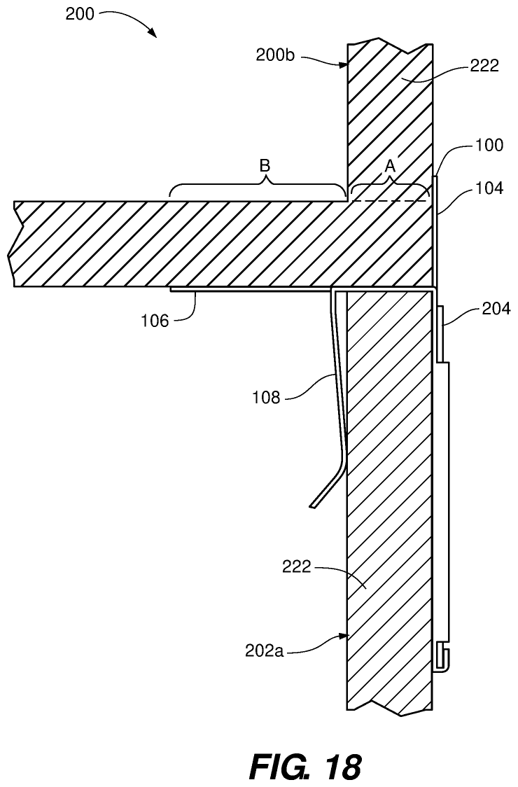

In an embodiment, and as depicted, top side 141, including left side 148 and right side 150, forms top surface 143, which is planar, and thereby configured to contact and support a bottom portion of a stacked storage bin 202 (see also FIGS. 17-18).

Left arm 108 and right arm 110 each project generally downward and away from base 106. In an embodiment, each arm 108 and 110 may be bent or angled inwardly toward rear side 113 of front plate 102. In one such embodiment, each arm 108 and 110 includes multiple portions, including a first or top portion 158 closest to base 106, a second or middle portion 160 and a third or end portion 162. In an embodiment, top portion 158 extends transversely from base 106, which may include forming an approximately acute angle with bottom surface 149. Middle portion 160 is connected to, and extends between, top portion 158 and end portion 162, in a direction that is downward and away from base 106 and that is also toward rear surface 114. End portion 162 is connected to middle portion 160, and in an embodiment, extends in a direction that is downward and away from middle portion 160, and also that is away from surface 113 of front plate 102. By extending in a direction that is away from surface 113 of front plate 102, a distance from the distal end of end portion 162 to surface 113 is increased, and is larger than width G of the arm gap, making it easier for a user to fit clip 100 over an edge of storage bin 202. Further, in an embodiment, a structural transition between middle portion 160 and end portion 162 is curved, forming a curved interface surface, as depicted, such that clip 100 is configured to easily slide over an edge or wall of storage bin 202 when being pushed onto the storage bin by a user.

As described further below with respect to FIGS. 15 and 16, by angling each arm 108 and 110 from base 106 back toward front plate 102 and its surface 114, when clip 100 is located onto storage bin 202, depending on a wall and/or edge thickness of the bin, arms 108 and 110 will exert a spring force onto the bin wall so as to hold clip 100 onto bin 202. As depicted specifically in FIG. 6, a gap having a width G is defined between each arm end portion 162 and surface 114 of front plate 102. In an embodiment, width G is smaller than length L of bottom left-side surface 152 and bottom right-side surface 154, such that clip 100 is configured to attach to a storage bin 202 that has a top edge thickness that can be as large as length L, and at the same time, exert a retaining force against an inside wall of the storage bin.

In an embodiment, width or distance G is in a range of 50% to 90% narrower than length L, in other words, a ration of G/L is 0.5 to 0.9. In another embodiment, a ratio of width G to length L is in a range of 0.6 to 0.75. The larger the difference in dimensions, the more force that is exerted by arms 108 and 110 onto storage bin 202, and the tighter the hold of clip 100 onto storage bin 202.

As depicted, each of the pair of arms 108 and 110 are located at the left-most and right most ends of base 106, and clip 100. Such a configuration maximizes the stability of clip 100 on storage bin 202.

In an embodiment, clip 100 comprises a metal material, such as steel, aluminum or other such metals or metal alloys. In other embodiments, clip 100 comprises a plastic or polymer material.

Clip 100 may comprise a unitary structure, as depicted, and may be constructed from a single sheet of metal material, or molded as a unitary structure of plastic or another material.

In the embodiment where clip 100 is manufactured from a single sheet of metal material, clip 100 is manufactured according to the following steps, which comprise a method of manufacturing a clip 100 of the invention:
1) Providing a substantially flat, bendable sheet-like material (“flat sheet”), such as steel;
2) Optionally covering or coating the sheet-like material, or portions thereof, with paint, film, and/or a coating;
3) Cutting, etching or punching a pattern onto the flat sheet to define front plate 102, stop tab 104, base 106, arms 108 and 110, and label-holding portions 124, 126 and 128;
4) Bending the portion of the flat sheet corresponding to base 106 rearwardly and away from the portion defined as front plate 102, leaving stop tab 104 extending upward and away from front plate 102 and forming opening 156, and causing base 106 to be at an acute angle with front plate 102;
5) Bending the portion of the sheet corresponding to arms 108 and 110 downwardly and away from base 106 to form arms 108 and 110; and
6) Bending the portion of the sheet corresponding to label-holding portions 124, 126 and 128 to form slots 130 with front plate 102.

Such a unitary embodiment of clip 100 is easier and cheaper to manufacture as compared to known clips that may require assembly of multiple parts, including requiring welding or gluing, or known clips that require elaborate and expensive molds.

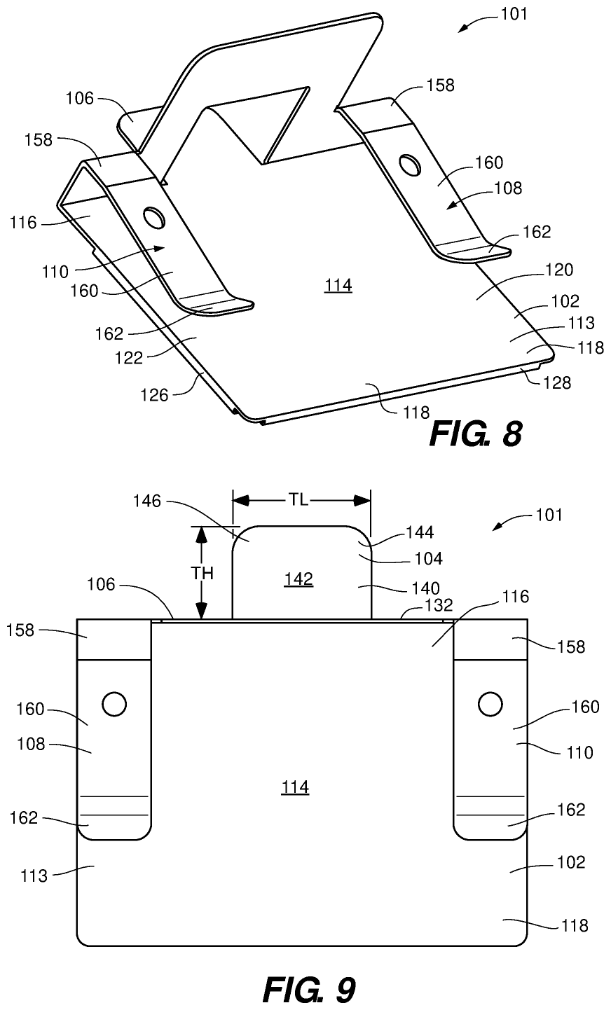

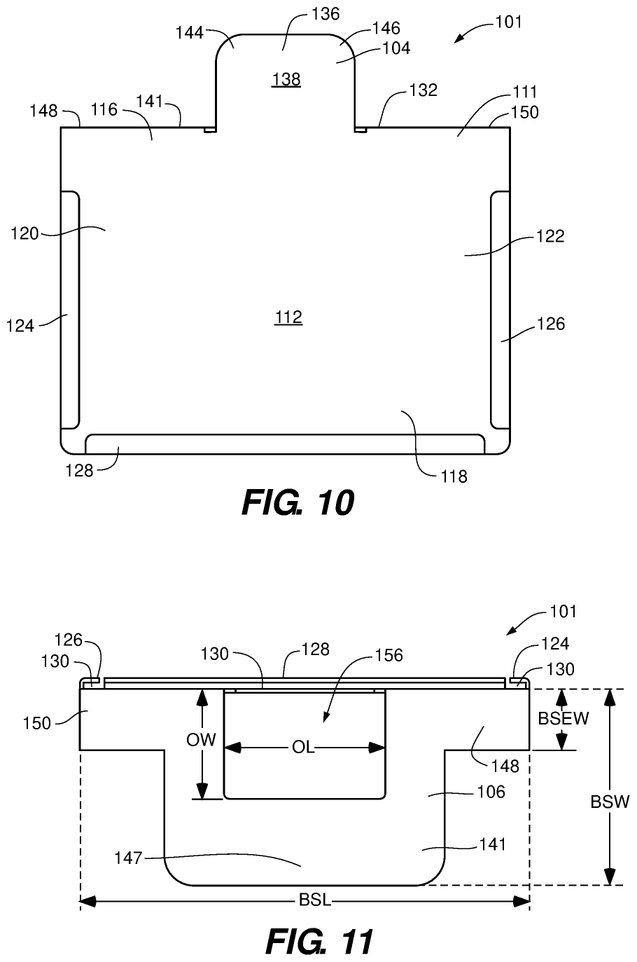

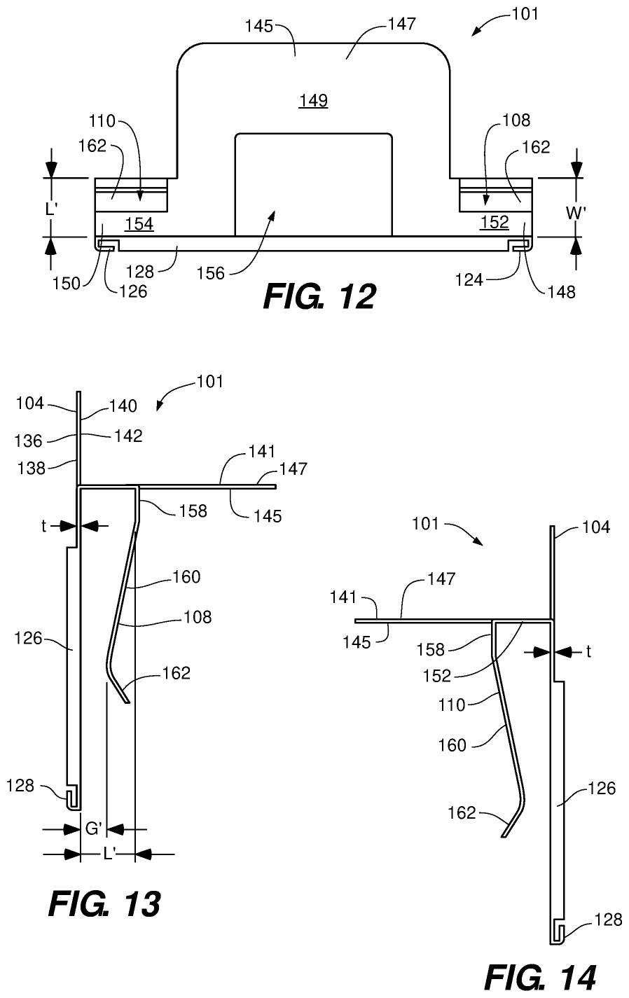

Referring to FIGS. 8-14, another embodiment of a stacking clip, clip 101 is depicted. Stacking clip 101 is substantially the same as stacking clip 100 that is depicted in FIGS. 1-7 and described above, with the exception of some dimensional differences. More specifically, clip 101 is configured to fit onto storage bins 202 that have a relatively thinner edge and/or wall thickness, as compared to clip 100 which is configured to fit onto storage bins 202 that have a relatively larger edge and/or wall thickness. As such, bottom left-side surface 152 and bottom right-side surface 154 of clip 101 defines a length L′ that is less than length L of clip 100. The gaps formed between arms 108 and 110 of clip 101 will also be smaller, having a dimension G′, which is less than G of clip 100. The ratios and relative dimensions of length L′ and G′ are substantially the same as widths W and G described above with respect to clip 100.

In an embodiment, length L is 50 to 100% larger than length L′, i.e., 1½ times to 2 times larger. In another embodiment, length L is approximately 80% to 100% larger than length L′.

Embodiments of the invention include a set of clips that include one or more clips 100 with length L and one or more clips 101, such that a variety of storage bin sizes may be used with clips 100 and/or clips 101.

Substantially all other features of clip 101 are the same as clip 100.

Referring to FIGS. 15-18, an embodiment of storage-bin-stacking-and-labeling system 200 (“system 200”) is depicted. System 200 includes one or more pairs of stacking clips 100, labeled as 100a and 100b, one or more storage bins 202, labeled as 202a and 202b, and optionally, one or more labels 204.

Referring to FIG. 15, in an embodiment, a first storage bin 202a is an open, lidless storage bin that comprises first wall 222, second wall 224, third wall 226, fourth wall 228 and bottom 230. The four walls define storage bin chamber 232.

Each wall includes a top edge, an inside surface and an outside surface. Accordingly, first wall 222 includes first top edge 234, first outside wall surface 236, and first inside wall surface 238 (see also FIG. 16); second wall 224 includes second top edge 240, second outside wall surface 242, and second inside wall surface 244; third wall 226 includes third top edge 246, third outside wall surface 248, and third inside wall surface 250; and fourth wall 228 includes fourth top edge 252, fourth outside wall surface 254, and fourth inside wall surface 256.

In an embodiment, storage bin 200, including storage bin 202a, comprises natural or synthetic woven material, a fibrous material, a fabric or natural fibers and materials, such as jute, wood, and so on. Walls 222, 224, 226, and 228 may comprise such material, such that their respective outside surfaces 236, 242, 248 and 254 may be rough or otherwise not configured to bond with an adhesive, and an adhesive-backed label will not stay attached to the surface. Referring also to FIG. 16, a left side view of stacking clip 100a mounted to first wall 224 of storage bin 202a, with first wall 222 depicted in cross section. In an embodiment, system 200 may include optional bin label 204. As described above, clip 100, in an embodiment, includes label-holding portions 124, 226 and 128 that form respective slots for receiving a label 204. As such, label 204 may be removable and reinsertable into stacking clip 100. As such, label 204 may comprise a card-like material, similar to an index card, having a size configured to be received by slots 130 of stacking clip 100 at left, right and bottom sides, to be held adjacent surface 113 of front plate 102 of stacking clip 100, and displayed to a user. As one of ordinary skill in the art would understand, such a label 204 might comprise any of a variety of materials, such as, though not limited to, paper, cardboard or plastic.

In other embodiments, label 204 may be configured for a single use, and may not be configured to be easily removed or reinserted. In one such embodiment, label 204 is adhesive-backed, such as an adhesive label.

As also described above with respect to FIGS. 1-7, surface 112 of front plate 102 may be configured to be written on by a user, such that use of label 204 is not necessary.

Referring to FIGS. 15-17, first stacking clip 100 (100a) is mounted to first bin wall 222 and second stacking clip 100 (100b) is mounted to third bin wall 226. As such, stacking clip 100a is located opposite to stacking clip 100b.

Left and right bottom surface portions 152 and 154 (see also FIG. 5) of stacking clip 100a are in contact with edge 234 of first wall 222; left and right bottom surface portions 152 and 154 (see also FIG. 5) of stacking clip 100b are in contact with edge 246 of third wall 226. Top surface 143 of stacking clip 100a is substantially coplanar with top surface 143 of second stacking clip 100b, which, as explained further below, provides a planar surface upon which a portion of second or upper bin 202 (202b) is placed.

Each stop tab 104 extends upwardly and away from respective edges 234 and 246 and outside wall surfaces 112, with a space between stop tabs 104 that is large enough to receive an upper bin 202b. The space between stop tabs 104 is equal to a bin width BW, such that another storage bin, such as bin 202b may be placed in the space and on clips 100 as described further below.

Base 106 width BSW (see also FIG. 4) is larger than a top width or thickness BT of the bin walls, such that base 106 extends from the bin wall, such as bin wall 222, perpendicularly to stop tab 104 and over an interior space of stacking bin 202. The additional distance that base 106 extends beyond edge 234 allows more surface contact area for a second bin 202 to have with clip 200, as compared to a clip that only is approximately as wide as the width or thickness of the bin wall, such that stacking stability is improved.

Arms 108 and 110 of each stacking clip 100 exerts a force F onto respective bin walls 222 and 226, and their respective inside surfaces 238 and 250, thereby securing clip 200 to wall 222 of stacking bin 202.

Referring specifically to FIGS. 17 and 18, a second or upper storage bin 200, labeled as 202b, is stacked upon lower bin 202a and clips 200a and 200b. Bottom 230 of storage bin 202b contacts, and is supported by bases 106 of the pair of stacking clips 100a and 100b. Stop tabs 104 of stacking clips 100a and 100b prevent or minimize movement of storage bin 202b in a direction perpendicular to stop tabs 104 and stop tab surfaces 142, which as depicted, is a widthwise direction parallel to bin width BW (see also FIG. 15).

Referring also to FIGS. 15-16, when upper storage bin 202b is substantially the same size as lower storage bin 202a, stop tabs 104 of clips 200 align first walls 222 through fourth walls 228 of lower storage bin 202a with respective first walls 222 through fourth walls 228 of upper storage bin 202b, thereby distributing the weight of upper storage bin 202b not only onto bases 106, but also onto respective top wall edges 234, 240, 246 and 258 of lower bin 202a, thereby equally distributing the weight of upper storage bin 202b onto lower storage bin 202a, improving the overall stability of the pair of stacked bins, and minimizing the possibility of damage to lower storage bin 202a.

Further, because bases 106 extend beyond the edges of upper bin 202a, and over bottom 230 of lower bin 202b, bottom 230 of upper storage bin 202b is supported not only at a bottom portion directly below its walls, such as bottom portion A at first wall 222, as depicted in FIG. 18, but bottom 230 is also supported at a bottom portion not directly below the bin walls, such as at bottom portion B.

This configuration not only ensures stability for the stacked bins 202, but also allows an upper storage bin 200b having a smaller width BW as compared to a width of the lower storage bin 202b to be stacked upon lower storage bin 200b. In one such embodiment of system 200 wherein upper storage bin 202b has a smaller width and lower storage bin 200b, walls 222, 224, 226 and 228 may not align at all with edges 234, 240, 246 and 258 of lower bin 202a, or may only partially align. In one such embodiment, upper storage bin 202b contacts only base 106 of stacking clips 100.

As described above, in an embodiment, second or upper bin 202b defines a bin width BW that is the same width as a bin width BW of first or lower bin 202a. In another embodiment, second or upper bin 202b defines a bin width BW that is less than the width BW of first or lower bin 202a. In an embodiment, a minimum bin width BW of upper bin 202a is just slightly larger than bin width BW of lower bin 202a less base width BSW of base 106 of clip 100. If the bin width BW of upper bin 202b is equal to or less than BW-BSW, then storage bin 202b will not be wide enough to be supported by bases 106. The term “slightly larger” means more than equal to, and at least larger enough such that a portion of bin bottom 230 of upper bin 202b can rest on surface 143 of base 106 of a first clip 100a and a portion of bin bottom 230 of upper bin 202b can rest on a top surface 143 of a second clip 100b.

In one such embodiment, bin width BW of upper bin 200b ranges from 100% of bin width BW of lower bin 200a, i.e., the bin widths BW are equal, the bin width BW of lower bin 200a minus 95% of the base width BW of base 106, i.e., BW−(0.95×BSW). Such an embodiment maximizes the range of possible bin sizes that may be stacked. In another embodiment, bin width BW of upper bin 200b ranges from bin width BW of lower bin 200a minus 50% of the base width BW of base 106. Such a range allows a range of usable bin widths, and also ensures stability of the stacked bins, preventing a portion of upper bin 202b from falling into lower bin 202a when disturbed or bumped.

Although system 200 is depicted with two stacking clips 100 on lower bin 202a, it will be understood that additional stacking clips 100 could be included. In one such embodiment, system 200 includes four stacking clips 100, one for each wall and edge of lower bin 200a. In such an embodiment, movement of upper bin 200b is prevented or minimized not only in a widthwise direction, but also in a lengthwise position.

Consequently, system 200, with the inventive clips 100 described herein, provide a unique and useful way to stack and label storage bins 202, particularly lidless, open-top bins having woven or rough sidewalls.

Based on the description above, the embodiments of the present disclosure also include methods for stacking and labeling storage bins 202, which include some or all of the following steps:
1) Grasping a first stacking and storage clip 100a, the stacking and storage clip 100a having a base 106, front plate 102, stop tab 104, and one or more support arms 108;
2) Placing stacking and labeling clip 100a directly onto a top edge of first storage bin 202a, such as first edge 234, such that a bottom 152 of the storage clip 100a directly contacts the first edge, stop tab 104 projects above the first edge 234, and support arms 108 exert a force onto walls of the storage bin 202a;
3) Placing a second stacking clip 100b on a second top edge of first storage bin 202a, such as edge 246, at a position opposite first stacking clip 100a, such that stop tab 104 of first stacking clip 104 projects above edge 246 and facing the stop tab 104 of the oppositely positioned first stacking clip 100a;
4) Grasping and lifting second storage bin 202b to align second storage bin 202b between the two stop tabs 104; and
5) Placing second storage bin 202b on the two base portions 106 of clips 100a; and
6) Inserting a label into a label-holding portion of one of the clips, or marking surface 112 with a marking device.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A storage bin stacking clip for clipping to a top edge of a first storage bin and for supporting a second storage bin stacked upon the first storage bin, comprising:
a bin support base including a base surface, defining a base length and a base width, and defining a base opening;
a front plate connected to the bin-support base, the front plate extending transversely from the bin-support base and including a front surface;
a bin stop tab extending from the front plate and including a front stop tab surface, the front stop tab surface being coplanar with the front surface of the front plate such that the front stop tab surface and the front surface of the front plate form a continuous front surface, the bin stop tab defining a stop tab length and a stop tab height, the stop tab length being less than the base length; and
one or more support arms extending transversely from the bin-support base.

2. The storage bin stacking clip of claim 1, wherein the front plate comprises a plurality of label-holding portions that define a plurality of slots configured to receive a bin storage label.

3. The storage bin stacking clip of claim 1, wherein the bin support base comprises a U shape.

4. The storage bin stacking clip of claim 1, wherein the bin support base comprises a left portion defining a first width, a second portion defining the first width, and a middle portion defining a second width, the second width being greater than the first width, such that the middle portion extends further in a widthwise direction perpendicular to the bin stop tab as compared to both of the left and right portions.

5. The storage bin stacking clip of claim 4, wherein the base opening defines a width that is substantially the same as the height of the bin stop tab.

6. The storage bin stacking clip of claim 5, wherein the base opening defines a length that is substantially the same as the width of the bin stop tab.

7. The storage bin stacking clip of claim 1, wherein the one or more support arms consists of two support arms, each of the two support arms having a middle portion extending in a direction toward a rear side of the front plate and each of the two support arms having an end portion extending in a direction away from the rear side of the front plate.

8. The storage bin stacking clip of claim 1, wherein the bin support base, front plate, bin stop tab and the one or more support arms comprise a unitary structure.

9. The storage bin stacking clip of claim 8, wherein the unitary structure consists of a metal material.

10. A storage bin stacking system comprising a first storage bin stacking clip of claim 1, a second storage bin stacking clip of claim 1, and a label configured to be received by a label-holding portion of either of the first or the second storage bin stacking clip.

11. The system of claim 10, further comprising a lidless storage bin.

12. A storage bin stacking and labeling clip for clipping to a top edge of a first storage bin and for supporting a second storage bin stacked upon the first storage bin, and for displaying a storage bin label, comprising:
a bin support base including a base surface, defining a base length and a base width;
a front plate connected to the bin-support base, the front plate extending transversely from the bin-support base and including a front surface, and a label-holding portion defining a slot configured to receive a portion of a label;
a bin stop tab extending from the front plate and including a front stop tab surface, the front stop tab surface being coplanar with the front surface of the front plate such that the front stop tab surface and the front surface of the front plate form a continuous front surface, the bin stop tab defining a stop tab length and a stop tab height; and
one or more support arms extending transversely from the bin-support base.

13. The storage bin stacking and labeling clip of claim 12, wherein the stop tab length is less than the base length.

14. The storage bin stacking and labeling clip of claim 13, wherein the bin support base defines an opening defining a length that is substantially the same as the stop tab length and a width that is substantially the same as the stop tab height.

15. The storage bin stacking and labeling clip of claim 12, wherein the front surface is coated with a material configured to receive a removable marking substance.

16. The storage bin stacking and labeling clip of claim 12, wherein the bin support base, front plate, bin stop tab and the one or more support arms comprise a unitary structure.

17. The storage bin stacking clip of claim 12, wherein the unitary structure consists of a metal material.

18. The storage bin stacking clip of claim 12, wherein the bin support base comprises a left portion defining a first width, a second portion defining the first width, and a middle portion defining a second width, the second width being greater than the first width, such that the middle portion extends further in a widthwise direction perpendicular to the bin stop tab as compared to both of the left and right portions.

19. A storage bin stacking system, comprising a first storage bin stacking clip of claim 12, a second storage bin stacking clip of claim 12, and a label configured to be received by a label-holding portion of either of the first or the second storage bin stacking clip.

20. A universal storage bin stacking system, comprising:
a first storage bin stacking clip according to claim 1, for clipping to a first storage bin;
a second storage bin stacking clip according to claim 1, for clipping to a second storage bin; and
a plurality of labels configured to be received by a label-holding portion of either of the first or the second storage bin stacking clip.
